(19) United States
(12) Patent Application Publication
(10) Pub. No.: US 2018/0075578 A1
(43) Pub. Date: Mar. 15, 2018

(54) VISION ASSISTANCE APPLICATION

(71) Applicants: Daniel Easley, Fletcher, OK (US); Candess Easley, Rockport, TX (US)

(72) Inventors: Daniel Easley, Fletcher, OK (US); Candess Easley, Rockport, TX (US)

(21) Appl. No.: 15/263,507

(22) Filed: Sep. 13, 2016

(51) Int. Cl. G06T 3/40; G09G 5/30

(52) U.S. Cl. CPC G06T 3/40; G09G 5/30; G09G 2340/14; G09G 2354/00; G09G 2320/08

(57) ABSTRACT

A method for adjusting a display screen of a portable electronic device based upon a user's eye prescription that includes the steps of: determining a base eye prescription for each user; inputting the base eye prescription into a means to control the display screen; and adjusting the size of content on the screen based upon the base eye prescription. The means to control the screen includes software stored on the portable electronic device.

### BACKGROUND OF THE INVENTION

### Field of Invention

The present invention relates to an application used to adjust images, content and words on the screen of a portable electronic device.

### Description of Related Art

Many individuals use portable electronic devices and computers on a regular basis. Many of these users have corrected vision through prescription glasses that address either nearsightedness or farsightedness. The vision of a user of a portable electronic device can affect the input and interaction with the device. Many portable electronic devices such as Smartphones and tablets include various settings that can be set to increase font size as needed. Although some of these settings aren't applicable with each software application used on a portable electronic device. As a result, it may be difficult for certain users who have corrected vision to interact with their device due to vision concerns. It would be advantageous if a screen of an electronic device could be adjusted in accordance with the corrective prescription for a user.

### SUMMARY OF THE INVENTION

The present invention relates to a method for adjusting a display screen of a portable electronic device based upon a user's eye prescription that includes the steps of: determining a base eye prescription for each user; inputting the base eye prescription into a means to control the display screen; and adjusting the size of content on the screen based upon the base eye prescription. The means to control the screen includes software stored on the portable electronic device.

### DETAILED DESCRIPTION

The present invention relates to a method and a system to modify content shown on a screen of a portable electronic device. The present invention provides a means to adjust the display of a screen based upon a user's corrective prescription for their eyes. The present invention ideally takes into account both nearsighted and farsighted corrective prescriptions. The process is accomplished through the use of a software application implanted onto the portable electronic device and controlled through the input of a user's visual prescription. A user may download the application from a central database as normally accomplished through the use of a portable electronic device such as a Smartphone or a tablet. Normally, the application is downloaded through a network such as a Wi-Fi or mobile data network connection. Once downloaded the application allows for the input of a user's corrective eye prescription. Based upon the input the screen is then manipulated to provide optimum visuals associated with such an eye prescription. This system as a result takes into account various ocular conditions such as myopia or hyperopia, as well as astigmatism. With these parameters provided, the application adjusts the display and content of the screen to provide a clear view for the user.

In particular, the method of the present invention includes adjusting the screen based upon a determination of a base eye prescription for each user. The user may input this base eye prescription through input controls provided on the electronic device. In most instances modern electronic devices have a touch screen for input and interactivity of a user. After the input of the base eye prescription the control system of the software application adjusts the size of content displayed on a display screen of the portable electronic device. Once adjusted the content remains consistent during use of the portable electronic device. The portable electronic device as stated above could be a Smartphone, tablet or in certain instances a computer. The software is implanted and integrated with the digital controls of the electronic device therefore providing instantaneous control of display on the device. The instant invention has been shown and described in what it considers to be the most practical and preferred embodiments. It is recognized, however, that departures may be made there from within the scope of the invention and that obvious modifications will occur to a person skilled in the art.

1. A method for adjusting a display screen of a smartphone or tablet based upon a user's eye prescription comprising the steps of:
a. downloading a software application from a central database and storing said software application on the smartphone or tablet;
b. inputting a base eye prescription for each user into a means to control the display screen; and
c. adjusting the size of content on the screen based upon the base eye prescription of a selected user.

2. The method for adjusting a screen according to claim 1, where the means to control the screen includes software stored on the portable electronic device.

3. The method for adjusting a screen according to claim 1, further where step of determining the base eye prescription includes inputting the base eye prescription using an input means of the portable electronic device.
